(19) United States
(12) Patent Application Publication
(10) Pub. No.: US 2011/0239281 A1
(43) Pub. Date: Sep. 29, 2011

(54) METHOD AND APPARATUS FOR AUTHENTICATION OF SERVICES

(75) Inventors: Sampo Juhani Sovio, Riihimaki (FI); Bror Lennart Svarfvar, Littoinen (FI); Terho Otso Tapio Kaikuranta, Piispanristi (FI)

(73) Assignee: Nokia Corporation, Espoo (FI)

(21) Appl. No.: 12/732,824

(22) Filed: Mar. 26, 2010

(51) Int. Cl. H04L 29/06

(52) U.S. Cl. 726/5

(57) ABSTRACT

An approach is provided for authenticating services at a device. An authentication request from a service platform is received at a device. Local credentials to authenticate access to a storage are retrieved. The access to the storage is authenticated based, at least in part, on the local credentials. If authenticated, it is determined that account information for the service platform is in the storage. The account information includes authentication credentials associated with the service platform, a security policy associated with the service platform, or a combination thereof. A response to the authentication request is generated based, at least in part, on the account information.

### BACKGROUND

Service providers and device manufacturers (e.g., wireless, cellular, etc.) are continually challenged to deliver value and convenience to consumers by, for example, providing compelling network services. However, many of these services, in general, require users to proactively take steps in setting up and authenticating via an account. Many of these registration schemes to set up accounts require a plethora of information from the user, deterring the user from activating and/or utilizing the services because the users do not wish to spend time registering. Setting up and using these authentication methods can thus be cumbersome, confusing, time consuming, and manually intensive. Consequently, many consumers may opt to forgo the services rather than be subjected to the complex, intrusive approaches to acquiring access to the services. Moreover, once an account is set up, the user generally needs to remember a username and/or password. Because users have many usernames and passwords, users may tend to use the same user name and password combinations. As a consequence, the passwords tend to be easy to remember and insecure. As a result, service providers and device manufacturers face significant technical challenges to creating a secure authentication system that is convenient for users and/or reduces the back-end service processing.

### SOME EXAMPLE EMBODIMENTS

Therefore, there is a need for an approach for providing a single sign-on solution at a device.

According to one embodiment, a method comprises receiving, at a device, an authentication request from a service platform. The method also comprises retrieving local credentials to authenticate access to a storage. The method further comprises authenticating the access to the storage based, at least in part, on the local credentials. The method additionally comprises, if authenticated, determining that account information for the service platform is in the storage, the account information including authentication credentials associated with the service platform, a security policy associated with the service platform, or a combination thereof. The method also comprises generating a response to the authentication request based, at least in part, on the account information.

According to another embodiment, an apparatus comprising at least one processor, and at least one memory including computer program code, the at least one memory and the computer program code configured to, with the at least one processor, cause, at least in part, the apparatus to receive, at the apparatus, an authentication request from a service platform. The apparatus is also caused to retrieve local credentials to authenticate access to a storage. The apparatus is further caused to authenticate the access to the storage based, at least in part, on the local credentials. The apparatus is additionally caused to, if authenticated, determine that account information for the service platform is in the storage, the account information including authentication credentials associated with the service platform, a security policy associated with the service platform, or a combination thereof. The apparatus is also caused to generate a response to the authentication request based, at least in part, on the account information.

According to another embodiment, a computer-readable storage medium carrying one or more sequences of one or more instructions which, when executed by one or more processors, cause, at least in part, an apparatus to receive, at a apparatus, an authentication request from a service platform. The apparatus is also caused to retrieve local credentials to authenticate access to a storage. The apparatus is further caused to authenticate the access to the storage based, at least in part, on the local credentials. The apparatus is additionally caused to, if authenticated, determine that account information for the service platform is in the storage, the account information including authentication credentials associated with the service platform, a security policy associated with the service platform, or a combination thereof. The apparatus is also caused to generate a response to the authentication request based, at least in part, on the account information.

According to another embodiment, an apparatus comprises means for receiving, at the apparatus, an authentication request from a service platform. The apparatus also comprises means for retrieving local credentials to authenticate access to a storage. The apparatus further comprises means for authenticating the access to the storage based, at least in part, on the local credentials. The apparatus additionally comprises means for, if authenticated, determining that account information for the service platform is in the storage, the account information including authentication credentials associated with the service platform, a security policy associated with the service platform, or a combination thereof. The apparatus also comprises means for generating a response to the authentication request based, at least in part, on the account information.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a single sign-on solution to authenticating services locally at a user device, according to one embodiment;

FIG. 2 is a diagram of the components of user equipment capable of providing a single sign-on solution to authenticating services, according to one embodiment;

FIG. 3 is a flowchart of a process for authenticating with a remote platform using local credentials, according to one embodiment;

FIG. 4 is a ladder diagram of a process for authenticating with a remote platform using credentials local to a user device, according to one embodiment;

FIG. 5 is a diagram of a user interface utilized in the processes of FIG. 3, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing a single sign-on solution at a device are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

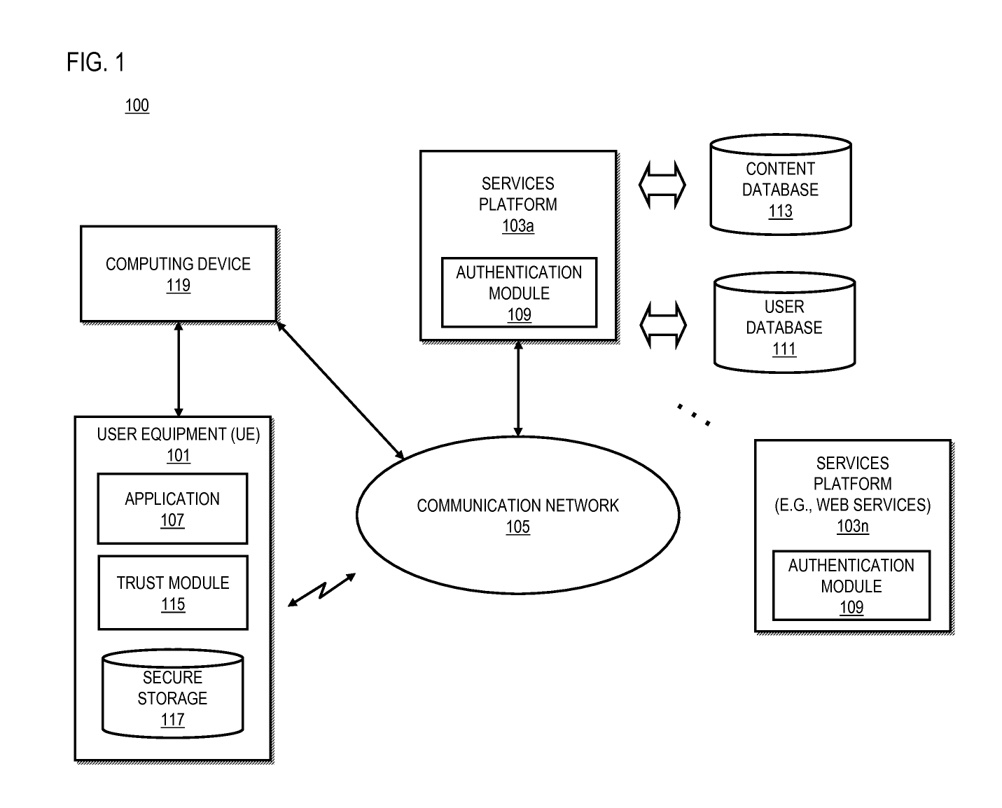

FIG. 1 is a diagram of a system capable of providing a single sign-on solution at a device, according to one embodiment. Network services, such as media services (e.g., music services, video services, photo services, etc.), navigation services, gaming services, and the like are increasingly being offered to users who can engage in these services using their devices. Some of these services require the use of an authentication approach. As such, the user may be required to activate an account and utilize the account when dealing with the services. Activation of such accounts may include collecting a variety of information from the user, such as the user's name, age, contact information, user name, password, etc. Moreover, activation may be time consuming and/or complex, thereby resulting in users not partaking in or otherwise utilizing or subscribing to the services. It is noted that service providers may have invested heavily in the development of such services; the return on this investment can be undermined if users are reluctant to even try the service because of the need to activate a user account for use of the service. In particular, users often fallback to specifying username/password combinations or other like authentication credentials that are often repetitive, similar, or otherwise insecure because the users may be overwhelmed the number of accounts they have created. For example, many people generate accounts based on a username, such as a user name associated with the user's actual name that can be easily guessed by a potential hacker. Moreover, if this name is taken, users often rely on modifiers (e.g., adding a number) to alter the username used with the service. Thus, users may select authentication credentials (e.g., user names and passwords) that are similar to other usernames that the user has previously used, leading to decreased security.

Further, once a user has authentication parameters set in association with the service provider, it can be difficult for the user to remember the username. This may occur when, for instance, a regular or common username is only lightly modified (e.g., by merely adding a number as described above). Thus, the user may forget which username is associated with which service. In another example case, if the user is forgetful of a previously registered username and/or password because combination is complex (e.g., because the service requires certain minimum standards), the user may write the username and/or password in a document or in another location where the user can retrieve it, thereby leading to potential comprise of the information.

Other insecurities can additionally be caused during the transmission of authentication credentials such as a username and/or password. This is because many hackers attempt to solicit the username and/or password of users for sites using a well known technique called phishing. Using this method, the hacker's system masquerades as a trusted entity (e.g., a bank, a store, etc.) and requests the username and/or password or other credentials from the user. If the user enters the username and/or password, the hacker can use the credentials to sign onto the actual service associated with the credentials. This security threat is undesirable to users as well as service providers.

To address this problem, a system 100 of FIG. 1 introduces the capability to provide a single sign-on solution to authenticating services locally at user equipment. With this approach, authentication credentials of one or more services are stored on storage of the user equipment (UE 101). A local authentication method is used to provide access to the authentication credentials. Then, a response (e.g., a response signal) is sent to a services platform 103 that requested the authentication to indicate that the user's credentials are valid and, therefore, the user is allowed access to the service. In addition or alternatively, the user's credentials may be automatically sent to the services platform 103 for direct authentication. In one embodiment, the system 100 authenticates the services platform 103 to ensure that that services platform 103 is authorized to receive the user's credentials before transmitting them. The services platform 103 can be one of a plurality of services platforms 103a-103n providing services to the user of the UE 101. The response can be sent via a communication network 105 to the services platform 103.

An application 107 of the UE 101 can request services from the services platform 103. One or more applications 107 can be executing on the UE 101. Applications 107 can be computer software designed to help a user perform one or more tasks. Examples of applications 107 include media presentation and/or creation (e.g., creation and/or presentation of images, video, audio, etc.) word processors, spreadsheets, database manipulation, web browsers, games, purchasing software, etc. Some of these applications 107 request services from the services platform 103.

These services can be provided to each application 107 that requests the services from the services platform 103 or may provide the services to the application 107 based on one or more forms of authentication via an authentication module 109. The services platform 103 can be associated with a user database 111 that is used to determine what services are available to a registered user. The user database 111 includes one or more identifiers of the user and/or the user's UE 101 or components of the user's UE 101. As such, a data structure can include one or more identifiers of the user, the UE 101 or other devices associated with the account as well as rights associated with the user (e.g., licenses for the user to download or use one or more services or content). Further, the rights associated with the user can differ based on one or more security policies requesting one or more different types of local authentication. For example, one set of rights may be associated with a code-based local authentication, while another set of rights is associated with a biometric data based local authentication. Services and content associated with the services can be stored in a content database 113 and provided to the user via the communication network 105. The content database 113 and/or the user database 111 can be located external to the services platform 103 and/or within the services platform 103.

Different approaches of authentication may be used by the authentication module 109 to determine whether the user should have access to the services. For example, authentication can be based on a username and/or password model, a security token, one or more security certificates, etc. Further, authentication procedures can be offloaded to a trust module 115 of the UE 101 and a confirmation signal is received by the authentication module 109 to determine that the user has access to the services. When a request for services is received at the services platform 103, the authentication module 109 can cause a transmission to be sent to the application 107 to request that the application 107 determine that the user should have access to the services available at the services platform 103.

The application 107 receives the authentication request from the services platform 103. The application 107 then causes retrieval of local credentials to authenticate access to a secure storage 117 associated with the UE 101. In certain embodiments, the secure storage 117 is a storage with one or more security features (e.g., encryption of files, encryption of a file system, etc). The retrieval of the local credentials and local authentication of the user can be accomplished using the trust module 115 or the application 107. The trust module 115 can retrieve the local credentials by causing a presentation of a prompt for a personal identity number (PIN), a local username and/or password, biometric information, or other methods of authentication to a user. The user then provides the local credentials to the UE 101 via an input mechanism such as a keypad, keyboard, touch screen interface, biometric sensor, camera, etc. In some scenarios, a lock state is caused during the prompting. In this state, the UE 101 functions are limited until the local credentials are entered, a predetermined time passes, a cancellation input is entered, or the like. If the local credentials are not entered, the requested service is not retrieved from the services platform 103. Otherwise, the trust module 115 receives the local credentials and compares the local credentials to credentials stored on the secure storage 117 or another memory of the UE 101. If the credentials match, or match, at least in part, to a threshold level, the trust module 115 sends a signal to the services platform 103 that the user has been authenticated. This signal can include a response that includes authentication credentials stored on the secure storage 117 that are associated with the services platform 103. The authentication credentials can additionally be a response formulated by the trust module 115 with a code known to the services platform 103. For example, the trust module 115 can receive a parameter with the authentication request that can be used in conjunction with a key stored on the UE 101 to generate the response. In certain scenarios, because local authentication is used, a simpler authentication mechanism may be used at the authentication module 109. For example, the authentication module 109 may simply check that a response is signed via one or more set of credentials. As such, the back-end processing at the services platform 103 can be reduced, which in turn saves computing resources and network bandwidth for supporting the processing.

In other embodiments, the response can be an unsecure acknowledgement that the user has been authenticated with one or more methods. The authentication request can determine the local method of authentication. Additionally or alternatively, a policy for determining authentication methods associated with the service can be used to determine the local authentication method. The policy can be stored in the secure storage 117 or another memory of the UE 101. The policy can associate a service of the services platform 103 with one or more authentication methods. For example, a first level of authentication may be a PIN code and a second level of authentication may be a biometric (e.g., fingerprint, iris, etc.) scan. As such, one services platform 103a may be associated with the first level of authentication while another services platform 103n may be associated with the second level of authentication. Thus, the methods of authentication can be determined by the trust module 115 by determining the policy associated with the services platform 103. Moreover, the trust module 115 can authenticate with the services platform 103 to verify that the services platform 103 is authentic. This can be accomplished by retrieving an identifier, such as an address (e.g., a uniform resource locator) associated with the services platform 103.

Further, a security policy can be set and used to determine the contents of the response to the services platform 103. One such policy can include transmitting an unsecured signal to the services platform 103. Another policy can include a form of key authentication where the authentication request includes information (e.g., a certificate) that the trust module 115 uses in conjunction with a key associated with the user, UE 101, secure storage 117, etc. to generate a secure response. The response is then determined to be valid or invalid at the services platform 103 to determine whether the services platform 103 should provide one or more requested services to the UE 101.

Additionally or alternatively, when services platform 103 initiates an authentication request to the application 107, the application 107 and/or trust module 115 can determine that an entry does not yet exist in the secure storage 117 for the services platform 103. In this scenario, the trust module 115 can generate a request to the services platform 103 to create a new account. The request can include new account information including authentication credentials such as username, password, etc., predetermined registration information (e.g., identifiers associated with the UE 101, information stored on the UE 101, etc.), a combination thereof, or the like. In certain embodiments, the username is unnecessary and an identifier of the UE 101 or hardware associated with the UE 101 (e.g., an international mobile equipment identity (IMEI), an international mobile subscriber identity (IMSI), a telephone number, a serial number, an e-mail address stored in the UE 101 etc.), is utilized to identify the account. In this manner, the user need not remember a username for the account. The authentication module 109 of the services platform 103 can then register the user/UE 101 using a user account in a user database 111. Further, the account can be associated with one or more rights or licenses. The user can purchase or acquire additional rights or licenses for the UE 101 or for use with the account. Additionally, the services platform 103 or other input to the UE 101 can be utilized to set up a security policy for the new account. The security policy can be stored on the secure storage 117 and include what type of information to be sent to the services platform 103 for authentication. Moreover, the security policy may be associated with one or more keys to encrypt responses to the services platform 103. Further, the security policy can include sending of the username and/or password information stored in the secure storage 117 to the services platform 103. In certain embodiments, the local credentials used to authenticate the user locally on the device are not sent to the services platform 103.

In one embodiment, a computing device 119 is utilized to generate a new account or transfer account information from one UE 101 to another UE 101. In one scenario, the computing device 119 may be at the point-of-sale of the UE 101 or the point-of-sale of services for the UE 101. For example, the user may purchase a service for the UE 101 or a an identifier that can be associated with the UE 101 such as a Subscriber Identity Module (SIM) that can be used to provide services to the UE 101. When acquiring a new UE 101 or SIM, the user may fill out registration information, which can be copied to a contact card storage on the user's UE 101 or another module (e.g., a SIM card) when the UE 101 is powered on (e.g., the first time the UE 101 is powered on). If certain registration information (e.g., an e-mail address) is missing, the registration information may be generated (e.g., a new e-mail address created and assigned to the user) for the UE 101, if applicable. Additionally or alternatively local credentials can be generated (e.g., a default PIN can be generated and communicated to the user) and the user may alter or be requested to alter the local credentials the first time local credentials are used or during an activation process for the UE 101. In another scenario, the computing device 119 may be utilized to copy the local credentials from the contact card of a used UE 101 to the user's new or current UE 101. In this scenario, the information in the secure storage 117 including the local credentials can be transferred to the current UE 101.

In some embodiments, a platform security implementation of the UE 101 allows for secure execution of signed applications 107 (e.g., the trust module 115). For example, the NOKIA BB5 based platforms support an implementation of secure storage 117 that can include highly confidential information such as SIM lock specific information as well as keys for Digital Rights Management (DRM). The NOKIA BB5 based secure storage 117 can be implemented separately from security provided by a service provider and/or operator providing access to the communication network 105. When an account is created, authentication information (e.g., a username/password for a services platform 103) is stored in the secure storage 117 as previously detailed. Then, when the services platform 103 requests the authentication information, the user need simply locally unlock the secure storage 117 to allow the application 107 to send verification that the user has access to the services of the services platform 103. An advantage of this approach is compatibility with current services platforms 103a-103n because the authentication information passed to the services platform 103 need not be modified. Thus, the system 100 includes a means for locally verifying access to one or more services on a services platform 103.

When the services platform 103 receives the authentication information, the services platform 103 can parse the authentication and determine a level of authentication for the user. Each level of authentication can be associated with one or more rights or licenses available to the user. For example, one right may be to download free music, another right may be to conduct one or more monetary transactions or monetary transactions above a predetermined threshold value, yet another right may be a right to purchase an application, or the like. The levels of authentication may be included in a response from the UE 101 to a request for the authentication information. As such, the local authentication level can be used to determine what rights are provided to the user. Thus, the system 100 includes a means for locally determining access levels of rights to services on a services platform 103.

In one embodiment, the services platform 103 uses an identifier of the UE 101 (e.g., a telephone number) as well as the authentication information in a response from the UE 101 to determine whether the UE 101 should be provided with one or more services. The identifier of the UE 101 is used to determine whether the UE 101 should have access to the services, while the response is used to determine that the user of the UE 101 should have access to the UE 101. In this manner, the access to the account can be tied both to the UE 101 and the user.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, and services platforms 103 communicate with each other and other components (e.g., other UEs 101) of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the services platform 103 may interact according to a client-server model. According to the client-server model, a client process sends a message including a request to a server process, and the server process responds by providing a service (e.g., maps, games, shopping, media download, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

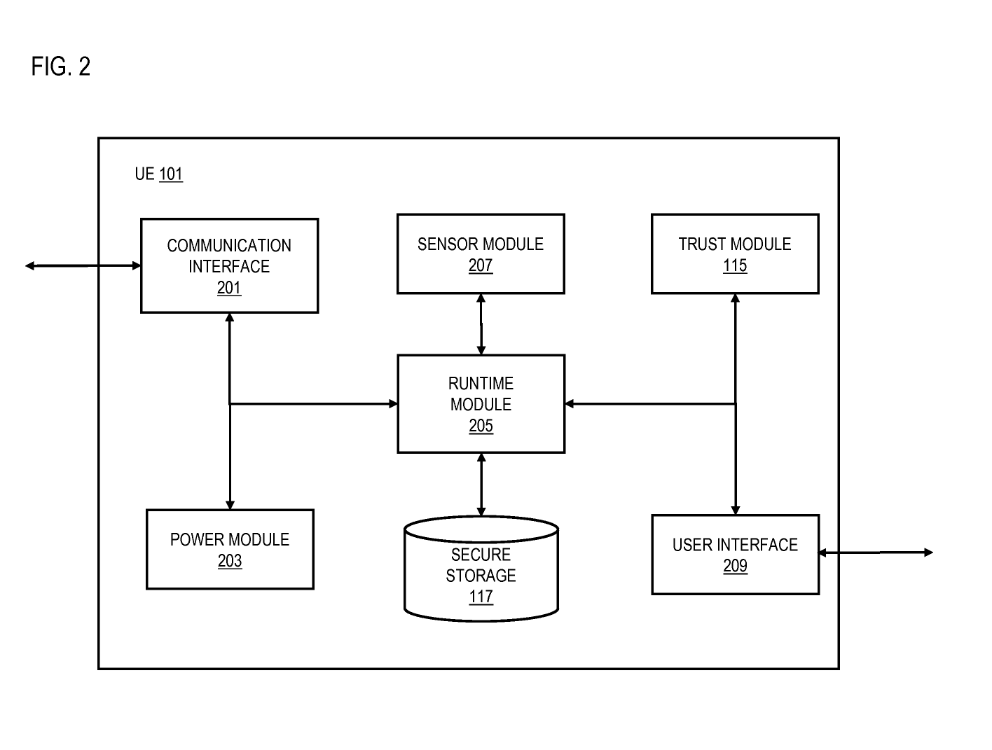

FIG. 2 is a diagram of the components of user equipment capable of providing a single sign-on solution to authenticating services, according to one embodiment. By way of example, the UE 101 includes one or more components for providing a single sign-on solution using local authentication. It is contemplated that the functions of these components may be combined in one or more components or performed by other components of equivalent functionality. In this embodiment, the UE 101 includes a communication interface 201, a power module 203, a runtime module 205, a secure storage 117, a trust module 115, a sensor module 207, and a user interface 209.

In one embodiment, the communication interface 201 can be used to communicate with the services platforms 103, other UEs 101, or other devices on the communication network 105. Certain communications can be via methods such as an internet protocol, messaging, or any other communication method (e.g., via the communication network 105). In some examples, the UE 101 can send a query or a request to utilize services to a services platform 103 via the communication interface 201. The services platform 103 may then send a response back via the communication interface 201 including a request for authentication of the user of the UE 101. Other components of the UE 101 can perform the authentication as described and a response can be sent to the services platform 103 via the communication interface 201. Moreover, once authenticated, the services platform 103 can provide one or more services or content (e.g., the requested service) to the UE 101.

The power module 203 provides power to the UE 101. The power module 203 can include any type of power source (e.g., battery, plug-in, etc.). Additionally, the power module 203 can provide power to the components of the UE 101 including processors, memory, and transmitters.

The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, a microphone, etc. Moreover, the user interface 209 may be used to prompt the user to enter local credentials (e.g., a PIN code, biometric sensor input, etc.) and receive local credentials from the user. An application 107 executing on the runtime module 205 can additionally lock the user interface 209 while requesting the local credentials.

The trust module 115 can be utilized to generate information used to conduct local authentication or another device (e.g., a computing device at a point of purchase). For example, the trust module 115 can be used to set up local credentials used for authentication. Different types of local credentials can be associated with one or more services platforms 103. Local credentials can be entered when the user purchases the UE 101 (e.g., during initialization) or a hardware identifier associated with the UE 101 (e.g., a SIM card). Personal information such as name, e-mail, address, phone number, etc. can be stored in the secure storage 117. Further, in certain embodiments, this information is transferred from a SIM card to a secure storage 117 on the UE 101 when a new SIM card is inserted to the UE 101. In other embodiments, the local credentials can unlock a SIM card lock, which can be used for authentication. As previously noted, the local credentials can include a PIN code, a local username and/or password, biometric information, or other authentication information. Further, in certain embodiments, the secure storage 117 can be used interchangeably with another memory.

The sensor module 207 may include biometric sensors and other sensors that provide a means to capture information, such as bar code readers. Biometric sensors such as fingerprint scanners, iris scanners, voice scanners (e.g., using a microphone) can capture biometric data and store it in a memory (e.g., the secure storage) of the UE 101. Then, the runtime module 205 may utilize the biometric data and compare it with stored local credentials. Images and/or audio can be captured using an image capture input device (e.g., a camera) or microphone associated with the sensor module 207. In one embodiment, visual media is captured in the form of an image or a series of images and sound is captured using discrete or continuous audio information. The sensor module 207 can be utilized by the runtime module 205 to capture audio or an image of the user or a portion of the user (e.g., a finger, palm, iris, face, etc.) for authentication. Moreover, the runtime module 205 can compare data points extracted from the images or voice audio to determine if the image/voice matches to a certain threshold level biometric or other data stored in the secure storage 117. In certain embodiments, the components of the sensor module 207 may be embedded in the UE 101 or may be an external addition to the UE 101. The sensor module 207 may be attached to the UE 101 using a network, such as a communication network or data network such as a bus (e.g., a universal serial bus (USB), a parallel bus, etc.).

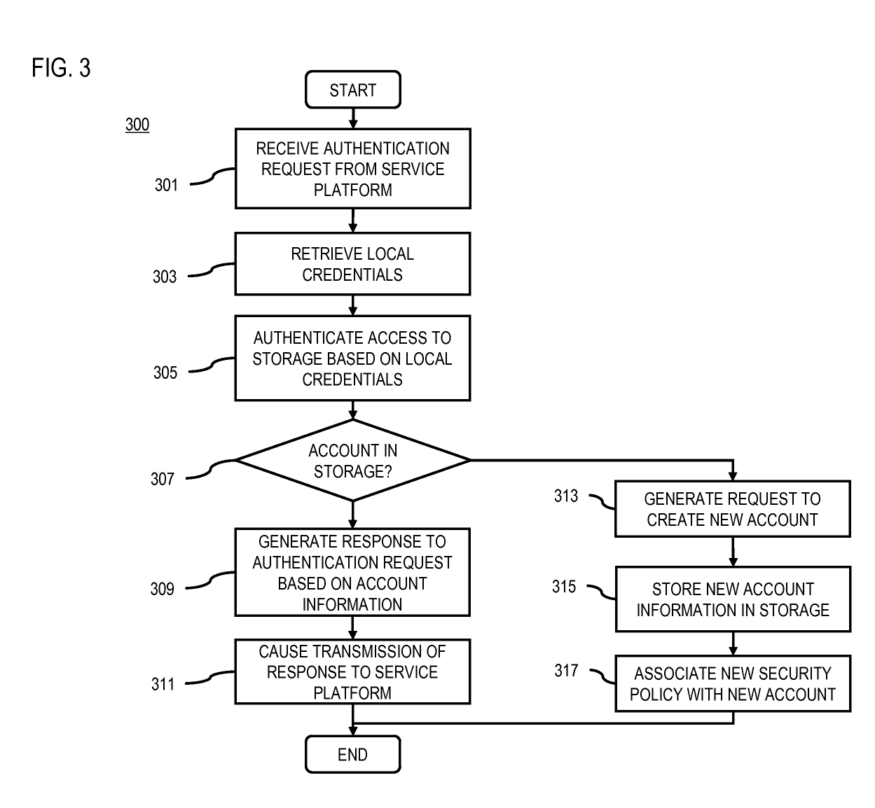

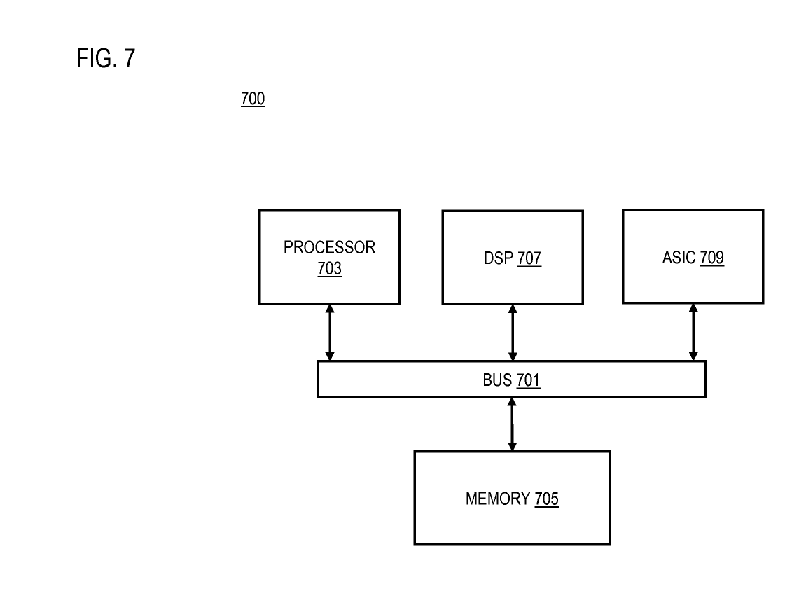

FIG. 3 is a flowchart of a process for authenticating with a remote platform using local credentials, according to one embodiment. In one embodiment, the trust module 115 and/or application 107 (e.g., executing on the runtime module 205) performs the process 300 and is implemented in, for instance, a chip set including a processor and a memory as shown FIG. 7. As such, the trust module 115, application 107, and/or runtime module 205 can provide means for accomplishing various parts of the process 300 as well as means for accomplishing other processes in conjunction with other components of the UE 101 and/or services platform 103. For simplicity, an application 107 of the UE 101 is used to describe the process 300, but it is noted that other processes or modules of the UE 101 can perform the process 300.

At step 301, the application 107 receives, at the UE 101, an authentication request from a services platform 103. This authentication request can be caused by an authentication module 109 of the services platform 103 in response to a request by the application 107 for services and/or content. Further, this authentication request may be utilized to cause the process 300 to be initiated. As such, the services platform 103 causes, at least in part, the UE 101 to perform one or more steps of process 300. In one example, the application 107 can request access to download music content from the services platform 103. The authentication request can be caused to determine whether the UE 101, user, or application 107 should be granted access to the music content. Further, the authentication request can cause the application 107 to locally authenticate with the user and send a response to the services platform 103 indicating whether the user should be granted the access.

Next, at step 303, the application 107 retrieves local credentials to authenticate access to storage (e.g., the secure storage 117). In certain embodiments, to retrieve the local credentials, the application 107 can cause, at least in part, actions that result in a lock state on the UE 101 upon receipt of the authentication request. The retrieving of the local credentials removes the lock state. If the local credentials are not entered within a certain predetermined time limit, the UE 101 can return to a state before the request was initiated and the application 107 is not granted access to the requested services or content. As noted above, local credentials can include a PIN code, biometric credentials, other authentication, etc. In one example, the UE 101 provides limited access unless the local credentials are provided, a time limit expires, or the user escapes from the lock state. This lock state can include a presentation requesting the local credentials.

At step 305, the application 107 authenticates the access to the secure storage 117 based, at least in part, on the local credentials. The application 107 can receive the local credentials and compare the local credentials to local credentials stored in a memory of the UE 101 such as the secure storage 117. These local credentials can be updated by the user and/or set while activating the UE 101, the application 107, etc. In certain embodiments, the trust module 115 is used to access the secure storage 117. As such, the trust module 115 is signed with permission to access the secure storage 117. In certain embodiments, for example, when the local credentials include biometric information, the application 107 receives the biometric information, analyzes the biometric information, and compares the analysis (e.g., extrapolated points of a fingerprint) with the stored local credentials. If the local credentials match to a certain threshold the stored local credentials, the authentication is valid. In the case of a PIN code or username and password local credentials, if the local credentials match the stored local credentials, the authentication is valid. If the local credentials are valid, the application 107 can have access to the secure storage 117 to generate a response to send the services platform 103. Further, a single set of local credentials can be used to provide access to more than one services platforms 103a-103n. As such, the authentication request can include an identifier (e.g., a URL) or other account information to indicate which services platform 103 the authentication request is associated with.

Next, at step 307, the application 107 determines that account information for the services platform 103 is included in the secure storage 117. The account information can include authentication credentials associated with the services platform 103, a security policy associated with the services platform 103, a means to determine authentication credentials for the services platform 103 (e.g., a key for a DRM associated with the services platform 103), or a combination thereof. Further, the account information can include one or more identifiers (e.g., URL, serial number, etc.) of the services platform 103 and/or services provided by the services platform 103. With this approach a data structure can be included in the secure storage that includes one or more identifiers of the services platform 103 (e.g., the URL, name, etc.), an account identifier associated with an account of the user (e.g., a phone number, serial number, username, etc.), a security policy for determining what information should be sent to the services platform 103 to verify that the user has access to the services and/or content of the services platform(s) 103. The application 107 can determine that the account information for the services platform 103 is in the secure storage 117 by comparing an identifier from the services platform 103 with the services platforms 103 identified in the data structure(s).

If the account information is found, the application 107 causes generation of a response to the authentication request based, at least in part, on the account information (step 309). The response can include account information that should be sent to the services platform 103 based on the security policy. In certain embodiments, the security policy is set in a manner such that different account information (e.g., authentication information associated with the user) can be sent to the services platform 103 based on a security level of the authentication request. As such, different account information can be sent to the services platform 103 based on the security policy. For example, the account information may include that the user has an account associated with the services platform 103, authentication information (e.g., a username and password) stored in the secure storage 117, a key that the application 107 can utilize to generate authentication information to send to the services platform 103, or the like.

Further, the response can additionally be based on an authentication of the services platform 103. In this manner, the application 107 can request that the services platform 103 provide authentication information (e.g., a signature, a key based authentication, etc.) that the services platform 103 can receive the authentication information. The application 107 can then verify that the services platform 103 is a valid requester of the authentication information based on the authentication. Certain security policies may be set so that only services platforms 103 that can be verified receive certain account information. For example, the application 107 can determine that the security policy allows including the authentication credentials in the response. The application 107 includes the authentication credentials in the response if the request of the services platform 103 can be verified to be authentic. As previously noted, these authentication credentials can be different from the local credentials. Then, at step 311, the application 107 causes, at least in part, transmission of the response to the services platform 103.

If, at step 307, the application 107 determines that the account information for the services platform 103 is not in the secure storage 117, the application 107 generates a request to the services platform 103 to create a new account (step 313). The request can include new account information including predetermined registration information and new authentication credentials. The predetermined registration information can be populated using information stored on a contact card or other storage of the UE 101. Next, at step 315, the application 107 causes storage of the new account information in the secure storage 117. This information can be in the form of the data structure described above that can include one or more identifiers of the services platform 103 (e.g., the URL, name, etc.), an account identifier associated with an account of the user, a security policy for determining what information should be sent to the services platform 103 to verify that the user has access to the services and/or content of the services platform(s) 103. Further, the application 107 associates a new security policy with the new account in the secure storage 117 (step 317). The new security policy for the new account can be received from the services platform 103 and/or be defined by the user.

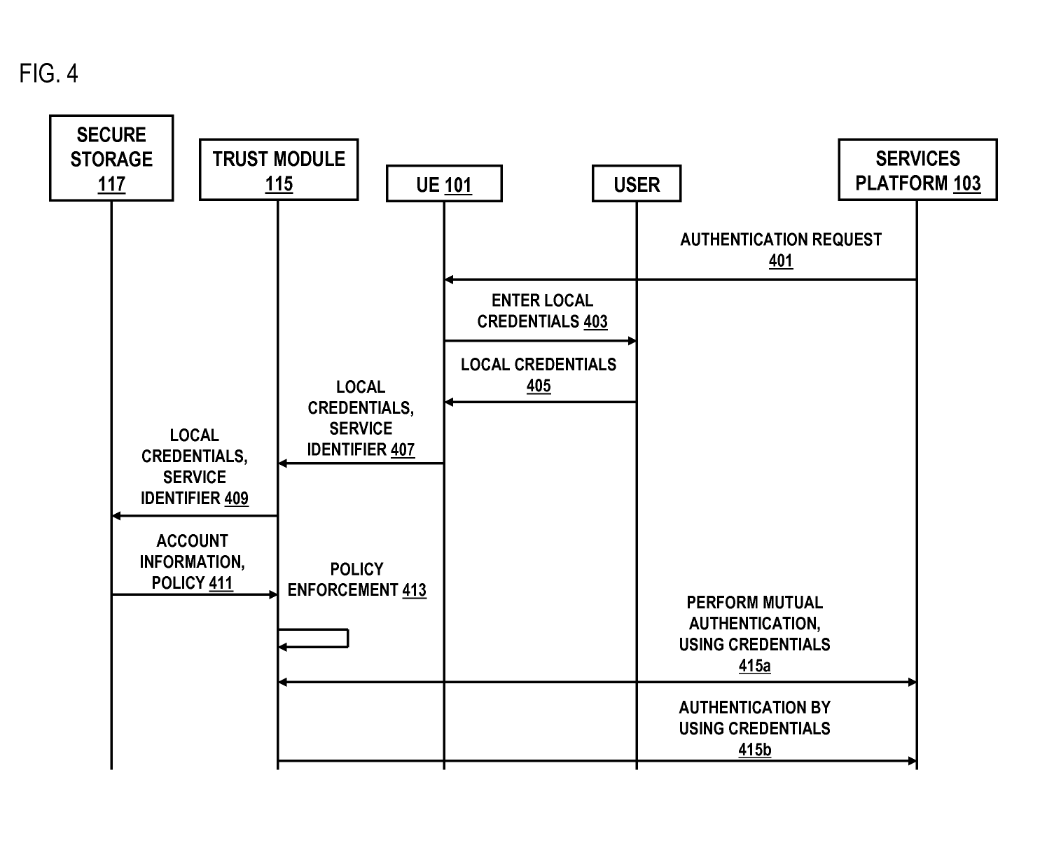

FIG. 4 is a ladder diagram of a process for authenticating with a remote platform using credentials local to a user device, according to one embodiment. A network process on the network is represented by endpoints of the vertical lines. A message passed from one process to another is represented by horizontal arrows. A step performed by a process is indicated by the text. At step 401, the UE 101 (e.g., via an application 107) receives an authentication request from a services platform 103. As noted above, the authentication request can be in response to a request for services by one or more applications 107 of the UE 101. The services platform 103 can optionally include one or more certificates or other information that may be used to authenticate the services platform's identity and/or to be used to generate a response to the authentication request.

Then, at step 403, the UE 101 requests a user to provide the UE 101 with local credentials. In certain embodiments, as noted above, the local credentials are credentials stored on the UE 101 that can be utilized to provide authentication for one or more services platforms 103 with one or more different authentication criteria. The local credentials can be a PIN code, biometric information, or the like. At step 405, the user enters the local credentials. In the case of biometric information, a sensor (e.g., a fingerprint sensor, a camera, etc.) can be used to enter the local credentials. In other cases, a touch screen input, keypad device, etc., can be used to enter the local credentials (e.g., a PIN code, local username and/or password, etc.).

The UE 101 sends the local credentials, a service identifier of the services platform 103 and/or a service of the services platform 103 to a trust module 115 of the UE 101 (step 407). The trust module 115 can be used to determine the authenticity of the communications from the services platform 103 (e.g., via processing an authentication certificate). In certain embodiments, the trust module 115 and the services platform 103 can be associated by a signature or other authentication mechanism to show a trust between the trust module 115 and the services platform 103. At step 409, the local credentials and service identifier (e.g., URL) are used to retrieve account information and/or a security policy from a secure storage 117. The security policy can be used to determine what account information to transmit to the services platform 103 for authenticating the user. Moreover, the security policy can be defined and/or modified by the user. For example, the user may change the security policy to only allow selected services platforms 103 to receive one or more types of credentials or particular credentials.

The security policy, at step 411, is sent to and received by the trust module 115. Then, at step 413, the trust module 115 enforces the security policy to generate a response to the authentication response. In one embodiment, the security policy is part of the account information for the service. As such, the enforcement of the security policy includes generating the response. The response can include information that verifies to the services platform 103 that the user is has been authenticated locally. By way of example, the response can be generated by using one or more certificates provided by the services platform 103 and/or a certificate or key associated with the account information to generate a coded response. In another example, the trust module 115 may be signed or have a coding mechanism associated with the services platform 103 to generate a coded response. Further, the coded response can include authentication information associated with the services platform 103 that is stored in the account information.

Moreover, in certain embodiments, one or more types of credentials (e.g., username and password, transport layer security authentication, key code, etc.) can be sent as part of the response. Additionally, in certain embodiments, the authentication and/or credentials sent to the services platform 103 are specific to the trust module 115 and/or other application 107 of the UE 101 rather than the user.

At step 415, the response is transmitted to the services platform 103 as part of authenticating the user. The authentication can include the trust module 115 requesting credentials from the services platform 103 to verify that the services platform 103 is a legitimate services platform 103 (step 415a). If authenticated, the response is sent. In other embodiments, the response can be sent to the services platform 103 without mutual authentication (e.g., step 415b).

Further, the services platform 103 can facilitate access, which can include granting access rights, based on the causing, at least in part actions that result in sending to the UE 101 the authentication request. This authentication can thus cause the UE 101 to further retrieve local credentials and authenticate access locally. The described processes and arrangement advantageously, according to certain embodiments, provide for facilitating access, by the services platform 103, to at least one interface to allow access to a service via at least one network. For example, granting access can include making network resources (e.g., bandwidth) available to the UE 101. Further, granting access may include the services platform 103 providing a web page interface for the UE 101.

In certain scenarios, as noted previously, because local authentication is used, a simpler authentication mechanism may be used at the services platform 103. With this simpler authentication approach back-end processing at the services platform 103 can be reduced, which in turn saves computing resources and network bandwidth for supporting the processing. For example, because the local authentication occurs, the services platform 103 may trust that the response is authenticated based on a signature in the response and need not re-authenticate.

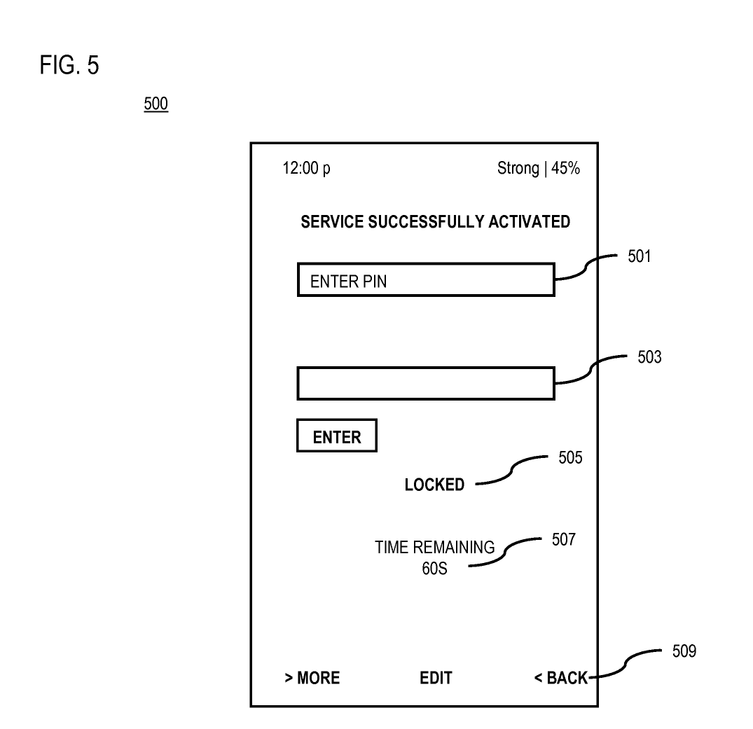

FIG. 5 is a diagram of a user interface utilized in the processes of FIG. 3, according to one embodiment. The user interface 500 shows a locked screen awaiting entry of local credentials by the user. In this example, the local credentials can be a PIN code. The PIN code request 501 can be presented on a portion of the screen. Further, a field 503 is provided for entry of the PIN code. The user interface 500 may limit access (e.g., lock 505 the screen) to the UE 101 while requesting the local credentials. As shown, the limited access can be overcome by entering the PIN code, waiting for a timeout 507, or escaping via a back field 509. If the local credentials are entered, the services from the services platform 103 requesting authentication can be provided after the UE 101 provides an authentication response to the services platform 103. Otherwise, if the back field 509 is activated or the timer 507 runs out, the services will not be provided to the UE 101. Further, additional security mechanisms may be utilized to prevent another user from attempting to fraudulently use services on the UE 101. For example, a timeout may be required between incorrect local credentials input.

With the above approaches, a user is able to securely receive services from services platforms 103 using local credentials. In this manner credentials to the services platform 103 are stored in a secure storage 117 on the UE 101. Local credentials can be used to access one or more credentials to services platforms 103. In this manner, the user of a UE 101 need not remember multiple complicated passwords to use the services on the user's UE 101. Further, with this approach, the processor time for authentication is reduced because the user may use a single authentication to acquire services from multiple services platforms 103.

The processes described herein for providing a single sign-on solution at a device may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

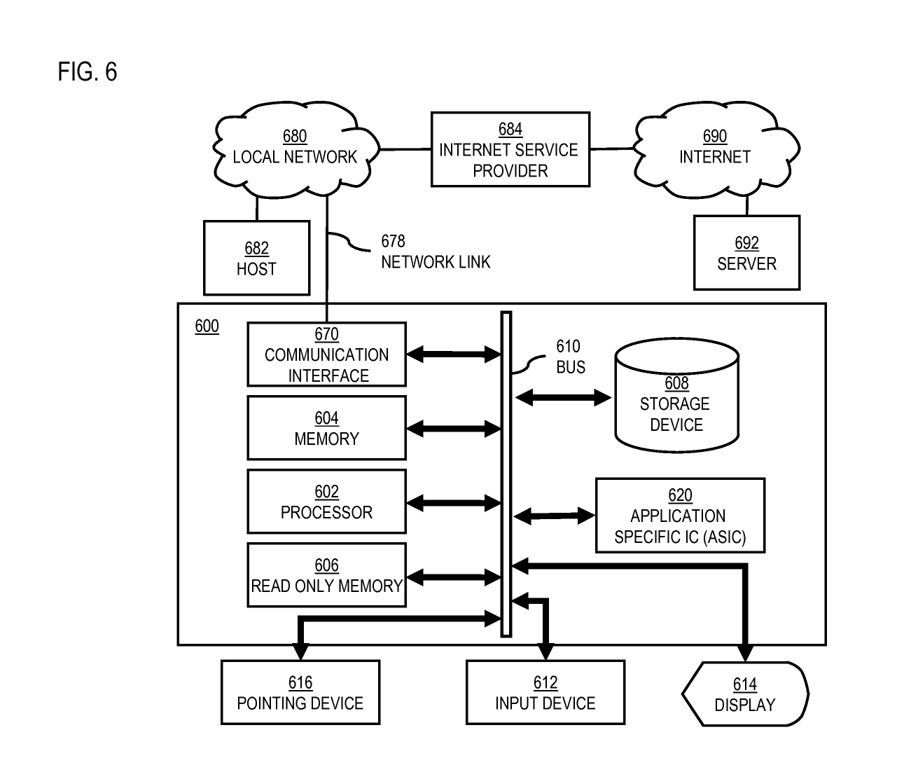

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide a single sign-on solution at a device as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing a single sign-on solution at a device.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing a single sign-on solution at a device. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing a single sign-on solution at a device. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a single sign-on solution at a device, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide a single sign-on solution at a device as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of services. Chip set or chip 700, or a portion thereof, constitutes a means for performing one or more steps of providing a single sign-on solution at a device.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a single sign-on solution at a device. The memory 705 also stores the data associated with or generated by the execution of the inventive steps.

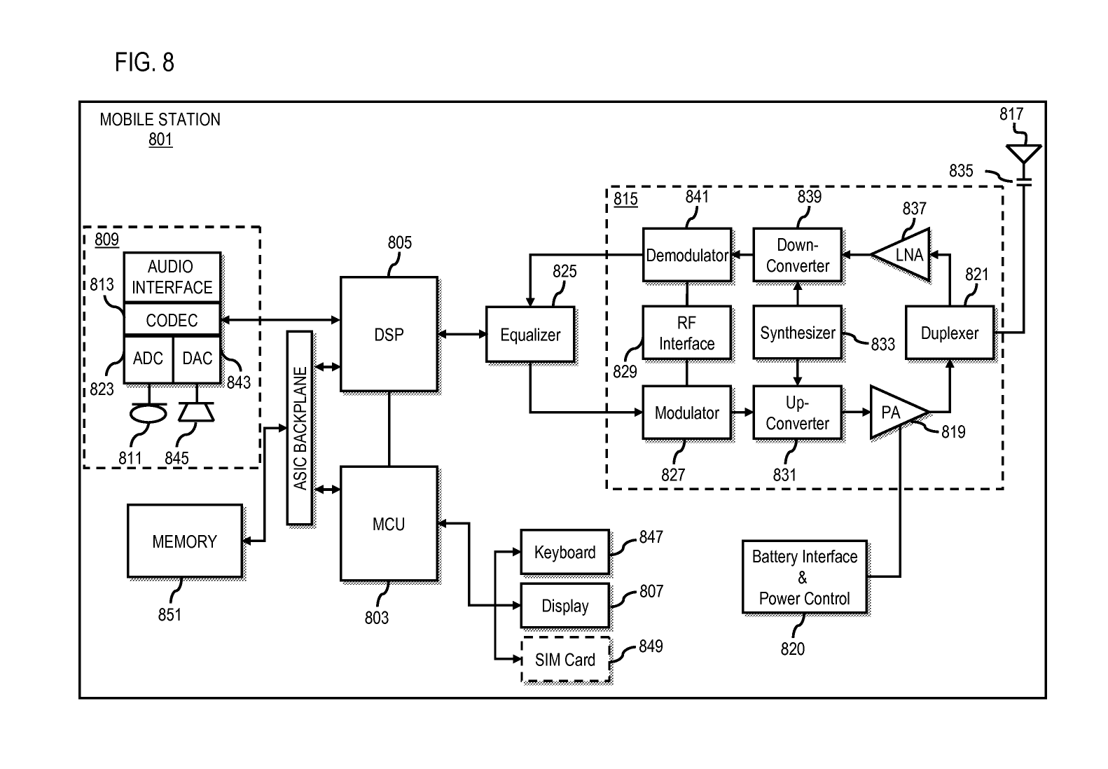

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of providing a single sign-on solution at a device. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing a single sign-on solution at a device. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide a single sign-on solution at a device. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving, at a device, an authentication request from a service platform;
retrieving local credentials to authenticate access to a storage;
authenticating the access to the storage based, at least in part, on the local credentials;
if authenticated, determining that account information for the service platform is in the storage, the account information including authentication credentials associated with the service platform, a security policy associated with the service platform, or a combination thereof; and
generating a response to the authentication request based, at least in part, on the account information.

2. A method of claim 1, wherein the generating of the response is further based on authenticating the service platform.

3. A method of claim 1, further comprising:
determining that the security policy allows including the authentication credentials in the response;
including the authentication credentials in the response; and
causing, at least in part, transmission of the response to the service platform.

4. A method of claim 1, further comprising:
causing, at least in part, actions that result in a lock state on the device on receipt of the authentication request,
wherein the retrieving of the local credentials removes the lock state.

5. A method of claim 1, further comprising:
determining that the account information for the service platform is not in the storage;
generating a request to the service platform to create a new account, the request including new account information including predetermined registration information and new authentication credentials; and
storing the new account information in the storage.

6. A method of claim 5, further comprising:
receiving a new security policy for the new account; and
associating the new security policy with the new account in the storage.

7. A method of claim 1, wherein the local credentials include a personal identity code, a biometric input, or a combination thereof.

8. A method of claim 1, wherein the storage is a secure storage with access limited to signed applications or processes.

9. An apparatus comprising:
at least one processor; and
at least one memory including computer program code,
the at least one memory and the computer program code configured to, with the at least one processor, cause the apparatus to perform at least the following, receive, at the apparatus, an authentication request from a service platform;
retrieve local credentials to authenticate access to a storage;
authenticate the access to the storage based, at least in part, on the local credentials;
if authenticated, determine that account information for the service platform is in the storage, the account information including authentication credentials associated with the service platform, a security policy associated with the service platform, or a combination thereof; and
generate a response to the authentication request based, at least in part, on the account information.

10. An apparatus of claim 9, wherein the generating of the response is further based on authenticating the service platform.

11. An apparatus of claim 9, wherein the apparatus is further caused, at least in part, to:
determine that the security policy allows including the authentication credentials in the response;
include the authentication credentials in the response; and
cause, at least in part, transmission of the response to the service platform.

12. An apparatus of claim 9, wherein the apparatus is further caused, at least in part, to:
cause, at least in part, actions that result in a lock state on the apparatus on receipt of the authentication request,
wherein the retrieving of the local credentials removes the lock state.

13. An apparatus of claim 9, wherein the apparatus is further caused, at least in part, to:
determine that the account information for the service platform is not in the storage;
generate a request to the service platform to create a new account, the request including new account information including predetermined registration information and new authentication credentials; and
store the new account information in the storage.

14. An apparatus of claim 13, wherein the apparatus is further caused, at least in part, to:
receive a new security policy for the new account; and
associate the new security policy with the new account in the storage.

15. An apparatus of claim 9, wherein the local credentials include a personal identity code, a biometric input, or a combination thereof.

16. An apparatus of claim 9, wherein the storage is a secure storage with access limited to signed applications or processes.

17. A computer-readable storage medium carrying one or more sequences of one or more instructions which, when executed by one or more processors, cause an apparatus to at least perform the following steps:
receiving, at a device, an authentication request from a service platform;
retrieving local credentials to authenticate access to a storage;
authenticating the access to the storage based, at least in part, on the local credentials;
if authenticated, determining that account information for the service platform is in the storage, the account information including authentication credentials associated with the service platform, a security policy associated with the service platform, or a combination thereof; and
generating a response to the authentication request based, at least in part, on the account information.

18. A computer-readable storage medium of claim 17, wherein the generating of the response is further based on authenticating the service platform.

19. A method comprising facilitating access, to at least one interface to allow access to a service via at least one network, the service configured to:
cause, at least in part, actions that result in sending to a device an authentication request;
cause, at least in part, the device to retrieve local credentials to authenticate access to a storage;
cause, at least in part, the device to authenticate the access to the storage based, at least in part, on the local credentials;
if authenticated, cause, at least in part, the device to determine that account information for the service platform is in the storage, the account information including authentication credentials associated with the service platform, a security policy associated with the service platform, or a combination thereof; and
cause, at least in part, the device to generate a response to the authentication request based, at least in part, on the account information.

20. A method of claim 19, wherein the service is further configured to:
cause, at least in part, the device to determine that the security policy allows including the authentication credentials in the response;
cause, at least in part, the device to include the authentication credentials in the response; and
cause, at least in part, granting of access rights to the device based on the response.

21.-53. (canceled)
